(19) United States
(12) Patent Application Publication
(10) Pub. No.: US 2006/0070838 A1
(43) Pub. Date: Apr. 6, 2006

(54) Locking device

(76) Inventor: Pierre Pellaton, Wetzikon (SZ)

Correspondence Address: HERSHKOVITZ & ASSOCIATES, 1725 I STREET NW, SUITE 300, WASHINGTON, DC, 20006, US

(21) Appl. No.: 11/228,313

(22) Filed: Sep. 19, 2005

(30) Foreign Application Priority Data
Sep. 20, 2004 (EP) 04 405 599.4

(51) Int. Cl. F16D 11/06

(52) U.S. Cl. 192/71

(57) ABSTRACT

The locking device comprises a base element 1 and a locking means (3), such as a bolt, which is actuated by an electrical drive, movable relative to the base element between a locking position and a release position. The base element is movably linked to an intermediate element (2) with respect to which the locking means is movable by the electrical drive means, whereas the intermediate element (2) is movably linked to the base element (1) and movable relative to the base element against a resistance of a spring force. A switching means (6) is actuated by a displacement of the intermediate element relative to the base element, wherein the switching means is operable to stop the electrical drive. By this mechanism, it is assured that the electrical drive is automatically halted when the locking means is blocked due to an incident of failure or because it has reached its end position. The invention also concerns a locking device wherein the intermediate element is movable relative to the base element by the electrical drive, wherein the locking means is movable relative to the intermediate element against the resistance of a spring force, and wherein a switching means detects a relative displacement of the locking means and the intermediate element.

### CROSS-REFERENCE TO RELATED APPLICATIONS

The present application claims priority under 35 U.S.C. 119 of EPO Patent Application No. 04 405 599.4, filed on Sep. 20, 2004, the disclosure of which is expressly incorporated by reference herein in its entirety.

### FIELD OF THE INVENTION

The invention is in the field of locking devices, especially of high security safe locks. It more particularly relates to locking devices according to the preambles of the independent claims.

### BACKGROUND OF THE INVENTION

More and more, purely mechanical locking systems are replaced by systems based on mechatronics, where the initiation of locking and release events depends on an electronic identification of the user. Upon clearance, the bolt of the lock is for example moved between the locking position and the release position by an electrical drive. Such an electrical drive may comprise conventional electric motors, stepper motors or may comprise an electromagnet and an anchor etc.

High security locks are widely used, for example for locking safes, vaults, strongrooms etc. Often, they are arranged behind thick security doors and security walls so that, when the object to be protected is locked, they are inaccessible, which prevents them from being manipulated. For this reason, security locks, next to being tamper-proof, also have to be highly reliable. A blocked lock in a locked safe, for example constitutes a major problem for the safe's owner.

For this reason, it has been proposed, for example in U.S. Pat. No. 5,840,198, to introduce redundancy in such systems. All parts needed for actuating the bolt are present twice, so that when one drive fails, the lock may safely be unblocked by the other drive. A frequent cause of failure is a blocking of the bolt due to some irregularity or because a locking member to be blocked or released by the bolt is not in a defined end position. Such an end position is a position in which the bolt is allowed to be brought into a its locking position in which it for example protrudes into a locking indentation of the locking member or an element connected to it. A blocking of the bolt may cause electrical motors driving the bolt to run in an overload mode, ultimately leading to overheating etc. In order to prevent such overheating, such electrical motors are often provided with conventional overload switches that measure the current consumed by the motors or their temperature. One disadvantage of such conventional overload switches are that they require a complicated electronics that has to be placed—for security reasons—inside the locked object, which electronics is a further potential reason for failure. Further, such overload switches are activated only when a certain threshold current or temperature is exceeded, and they therefore cannot prevent a certain damage or at least increased wear to the drive caused by overload before the threshold value is reached. Also, in such a blocking condition, the drive has to be re-activated regularly in order to operate again if the blocking of the bolt is remedied. This however, in situations where the blocking remains for a long time, causes a high consumption of electricity by the drive that is almost always battery powered.

Often as an alternative or in addition to the overload switches, position switches detecting the position of a locking member and only allowing actuating of the bolt when the locking member is in a defined end position. However, such a switch may shift over the years, causing failures. They also require additional long transmission lines between switch and locking device. Also, such a switch may not detect failures caused by some irregularities.

It would be desirable to have a locking system with an overload protection for the drive that is as simple as possible and that avoids the disadvantages of prior art systems.

### SUMMARY OF THE INVENTION

It is therefore an object of the invention to provide a locking device overcoming disadvantages of prior art locking devices, which locking device especially provides a simple and reliable mechanism to avoid situations where the drive is overloaded. Preferably, the mechanism should be such that the locking device automatically starts to be operational again once the blocking is eliminated.

These objects are attained by a locking device according to the claims.

The locking device comprises a base element—which is for example mechanically very stable and may be affixed to a door or a frame of the object to be locked—and a locking means (for example a bolt or a driving element for actuating a bolt of a cylindrical or other lock), which is, actuated by an electrical drive, movable relative to the base element between a locking position and a release position. According to the invention, an intermediate element is provided which is movably linked to the base element and to which the bolt is movably linked.

According to a first embodiment of the invention, the locking means is actuated by being moved, by the electrical drive, relative to the intermediate element, whereas the intermediate element is movable relative to the base element, against the force of a spring, out of an equilibrium position. A sensing means detects a movement of the intermediate element out of its equilibrium position and then stops the drive. If the locking means is blocked due to some irregularity or also because it abuts a stop, the drive, by further moving the locking means and the intermediate element with respect to each other, displaces the intermediate element relative to the base and cause the switching means to be actuated. By this, the drive is automatically stopped.

The term ‘electrical drive’ refers to any electrically powered means operable to cause a displacement of two parts with respect to each. This includes classic rotary electric motors with a corresponding driving mechanism, but also other drive means based on electrical power, such as linear motors, piezoelectric motors, drive means based on the magnetic force caused by an electromagnet and an anchor, hydraulic drive means etc.

The sensing means may be mounted on the base element. It may be sensor operable to detect a replacement, such as an optical sensor, an electric or electronic sensor, a magnetic sensor, a proximity sensor, a motion sensor etc. Such a sensor or detector is for example connected to an electrically actuated switch which halts the electrical drive. Instead of a switch, a circuit gradually regulating the electrical drive as a function of the displacement or similar may be present. The sensing means may also be any kind of switch actuated by the displacement of the intermediate element body itself or by a switching pin or the like connected to the intermediate element. The switch may comprise micro-switches or other switching means and may comprise a mechanically actuated switch, a reed relay, an electrical contact switch, a non-contact switch, etc.

If the relative distance between the equilibrium position and of the intermediate element and the position in which the switch is actuated is the switching distance d and the spring constant of the spring is K, the electrical drive is switched off by the switching means if
Fₑₓₜₑᵣₙₐₗ>F_{preload}+d*K

F_{preload} is a potential pre-load force that may be present if the spring is pre-loaded in the equilibrium position and presses the intermediate element against some abutment.

A condition, therefore, is that the total force of the electrical drive exceeds F_{preload}+d*K.

The electrical drive or another means blocks the locking means in its actual position when it is switched off by the switching means.

According to a second embodiment, the locking means is actuated by the intermediate element being moved, by the electrical drive, relative to the base element. The locking means, being kept in an equilibrium position by at least one spring, takes part in this movement. If the locking means is blocked due to some irregularity or also because it abuts a stop, the drive, by further moving the intermediate element with respect to the base element, displaces the intermediate element relative to the locking means and causes a sensing means to automatically halt the drive.

The above consideration of the forces involved applies mutatis mutandis also for the second embodiment.

On an abstract level, the two embodiments of the invention may be subsumed as follows: The locking device according to the invention comprises three elements.

The locking device is actuated by displacing the first and the third element with respect to each other. The first element is connected to the third element via the second element: The second element is connected to the first element in a manner that it is displaceable against a resistance of a spring force. The third element is connected to the second element in a manner that it is displaceable, actuated by an electrical drive between a locking position and a release position. The electrical drive is connected to a switching means that is actuated by a relative movement of the first and the second element with respect to each other. According to the first embodiment, the first element is a base element that may be fixed to an object such as a door, a frame or the like, and the third element is a locking means. According to the second embodiment, the third element is the base element that is usually fixed to an object and the first element corresponds to the locking means.

The intermediate element may for example be in the form of a slide linearly displaceable with respect to the base element.

The locking means may be a bolt or a driver of a lock (for example directly or indirectly driving a bolt) or another means locking an object against another object or co-operating with an element that is operable to lock one object against another object, such as a door against a frame.

In a cylindrical arrangement, the base element may be a stator, and the locking means may be a rotor, whereas the intermediate element is pivotable relative to the base element.

The invention provides a very simple and therefore reliable mechanism for detecting failures in locking devices of the dead-bolt (or direct drive) type. The mechanism only requires a minimum of electronic parts. For this reason, the locking device according to the invention is especially suited where high security and reliability is required.

Further, the same mechanism allows the drive to detect when the bolt is in a well defined position, for example in the locking position or the release position abutting a (optional) stop pin or the like. Therefore, no separate means for detecting this such as photo sensors etc. is required. This adds to the value of the system of the invention being simple and reliable.

The only parameters to be considered and to possibly be adjusted are the switching distance d (possibly being the distance of the sensing means, for example switch(es), from the intermediate element or the locking means, respectively) and the spring constant(s). No electronic control is required for monitoring the basic function. Especially, no firmware is required.

Also, no separate force sensors, no means for measuring the current consumed by electrical motors (which measurement may be delicate for battery powered devices) or temperature measurements are required.

Further, as soon as the external force blocking the locking means disappears, the locking means may automatically start to move again: Initially the spring force moves the intermediate element (or the locking means, respectively) back to the equilibrium position, whereby the electrical drive is automatically activated.

All switching elements may be integrated locally in the driving source, i.e. in the locking device, for example within its shell or housing. No external, remote sensors are required. This is especially beneficial where the locking device is used for blocking/releasing a usually much larger locking member such as a lock bar and not directly for locking the object: Then, external sensors testing the state of the locking member would be rather remote. By the concept of the invention, the testing of the state of the locking member is done by the device according to the invention itself (integrated solution).

In both embodiments, the principle of the invention may work bi-directionally. This means that the intermediate element (or the locking means, respectively) is movable from the equilibrium position against a spring force (possibly caused by two or more springs) to two directions into two extreme positions, and movement in either direction activates a switching means. Preferably, two separate switches are present for this purpose, one activated by a movement in one direction, the other one by a movement in the other direction. By this, one can assure that the system when the electrical motors during movement in one are switched off by one switch may still be activated to move in the other direction even if the one switch is blocked in the switch-off position. As an alternative to two switches being present, also one switch with at least three switching states to be for example mechanically actuated in two directions may be chosen.

According to a preferred realisation of the invention, the drive is provided in a redundant manner, i.e. more than one electrical motor (or the like) is present. Separate switches for each motor may be provided, so that with two motors a total of four switches (one per direction for each motor) may be present.

According to special realisation, two or more switches may be positioned in distances d₁, d₂, . . . ,dₙ, where only the last switch halts the drive. The states of the other switches indicate, as a kind of force sensor, the strength of the external force acting upon the locking means. This information may be used by the control electronics in any suitable manner, for example the information may be used to determine whether the locking systems has to undergo a revision if the force necessary to displace the locking means keeps increasing. Instead of a plurality of switches, the switching means may comprise a single switch with a plurality of switching positions, the single switch being able to distinguish between different levels of displacement.

Yet another special realisation may provide a special additional sensor or switch operable to evaluate when the locking means is in a regular pre-defined end position in order to distinguish an incident of failure from an ordinary reaching of the end position.

### BRIEF DESCRIPTION OF THE DRAWINGS

In the following, embodiments of the invention are described with reference to drawings. In the drawings, same numerals are used to refer to like elements.

FIG. 1 shows a very schematic picture of a first embodiment of a locking device according to the invention.

FIG. 1a illustrates the function principle of the embodiment of FIG. 1.

FIG. 2 shows an—also very schematic—picture of a second embodiment of the invention.

FIG. 3 illustrates a common principle of both embodiments of the invention.

FIG. 4 shows a realisation of the first embodiment of the invention.

FIG. 5 depicts a scheme of the wiring of the switches and motors of the realisation of FIG. 4.

FIG. 6 shows—in a picture drawn to scale of the realisation of the first embodiment of FIG. 4—details of the driving mechanism of the bolt.

FIG. 7 shows very schematically a realisation of the first embodiment of the invention in a cylindrical arrangement.

### DESCRIPTION OF THE PREFERRED EMBODIMENTS

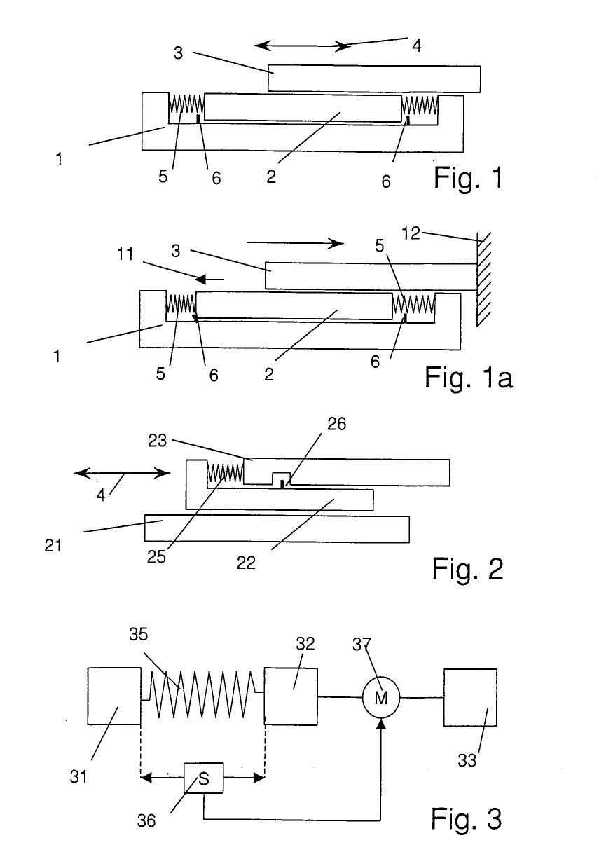

FIG. 1 depicts a very schematic picture of a first embodiment of a locking device according to the invention. The locking device comprises a base 1 which may for example be fastened to a door or to a frame of a door. An intermediate element 2, namely a slide 2, is mounted on the base in a manner that it is movable relative thereto. This may for example be achieved by a slide contact bearing (not shown) arranged between base and slide. On the intermediate element, a locking means 3, namely a bolt is arranged. The bolt is movable relative to the slide by an electrical drive, as indicated by an arrow 4 in the figure. The slide 2 is kept in an equilibrium position—or central position—by at least one spring 5 (two springs in the shown embodiment). It may be moved—at least to some extent—against the force of the springs 5. The locking device further comprises switches 6, which are actuated by a movement of the slide 2 relative to the base 1 out of the equilibrium position. The switches serve as sensing means since they, by being actuated, detect a displacement of the slide with respect to the base 1. They interact with the electrical drive and are operable to stop the same upon being actuated.

The embodiment of the invention works as follows: When the locking device is activated, the bolt is moved between the locking position and the release position by the electrical drive. As soon as the bolt is stopped—either by a limit stop, because the bolt abuts a stop face of a locking member or because it is blocked in an irregular position—the slide is caused to move relative to the base against the force of the springs. For example, if the bolt is moved blocked while moving towards the locking position, as illustrated in FIG. 1a, the slide is forced, by the electrical drive, further away from the bolt in the direction indicated by arrow 11. As soon as the switch is actuated, the electrical drive is halted, and the slide and the bolt remain in their relative position. The spring force causes a force to press the bolt against the obstacle 12 even when the drive is halted. Immediately after removing the obstacle 12, the intermediate element goes back to the equilibrium position, and the bolt moves on. The wiring may further be such that in the blocked position shown in FIG. 1a the electrical drive may still be activated to move the bolt in the other direction, away from the obstacle 12. Such a wiring is shown further below.

This set-up provides a relatively little complex but very reliable way of preventing the electrical drive from being in an overload situation, and at the same time is a mechanism to stop the drive when the bolt has reached an end position without the need of additional laborious measures for detecting its position.

A second embodiment of the invention is very schematically shown in FIG. 2. This embodiment relies on a similar principle. However, in this embodiment, the drive moves the slide 22 relative to the base 21. The bolt 23 is mounted to the slide and moveable relative thereto against the force of a spring 25. When the locking device is activated, the slide with the bolt is moved between the locking position and the release position by the electrical drive. As soon as the bolt is stopped—either by a stop or because it is blocked in an irregular position—the bolt is caused to move relative to the slide against the force of the spring, and the switch 26 is actuated to halt the drive.

FIG. 2 also illustrates how the functionality of the two switches 6 of FIG. 1 may be implemented by a single switch. It is assumed that the switching states of the switch 26 differ dependent on which direction the switch is moved to. Also, in FIG. 2 only one spring is present, the relaxed state of the spring defining the equilibrium position. The first embodiment, although its functional principle may seem more indirect and is more sophisticated, has some advantages over the second embodiment. Whereas the electrical drive usually has to be arranged on the slide, the switch or switches and potential circuitry may be arranged on the base and do not have to be movable.

Therefore, in the following description, embodiments having this functional principle are described in somewhat more details. However, the expert will, having the knowledge of both functional principles and being confronted with descriptions of the first embodiments, readily know a way to implement embodiments having the second functional principle. Also, there will be situations where the second embodiment is better suited, for example where for practical reasons a movement of the electrical drive relative to the base is not advisable, for example since the drive is directly mounted to the object to be locked.

On an abstract level, the two embodiments of the invention may be described to have one common principle illustrated in FIG. 3: The locking device according to the invention comprises three elements 31, 32, 33. The locking device is actuated by displacing the first and the third element with respect to each other. The first element 31 is connected to the third element 33 via the second element 32: The second element 32 is connected to the first element 31 in a manner that it is displaceable against the resistance of a spring 35. The third element 33 is connected to the second element 32 in a manner that it is displaceable, actuated by an electrical drive 37 between a locking position and a release position. The electrical drive 37 is connected to a switching means 36 that is actuated by a relative movement of the first and the second element with respect to each other. According to the first embodiment, the first element 31 is a base element that may be fixed to an object such as a door, a frame or the like, and the third element 33 is a locking means, such as a bolt or a driving element of a cylindrical lock). According to the second embodiment, the third element 33 is the base element that is usually fixed to an object and the first element 31 corresponds to the locking means.

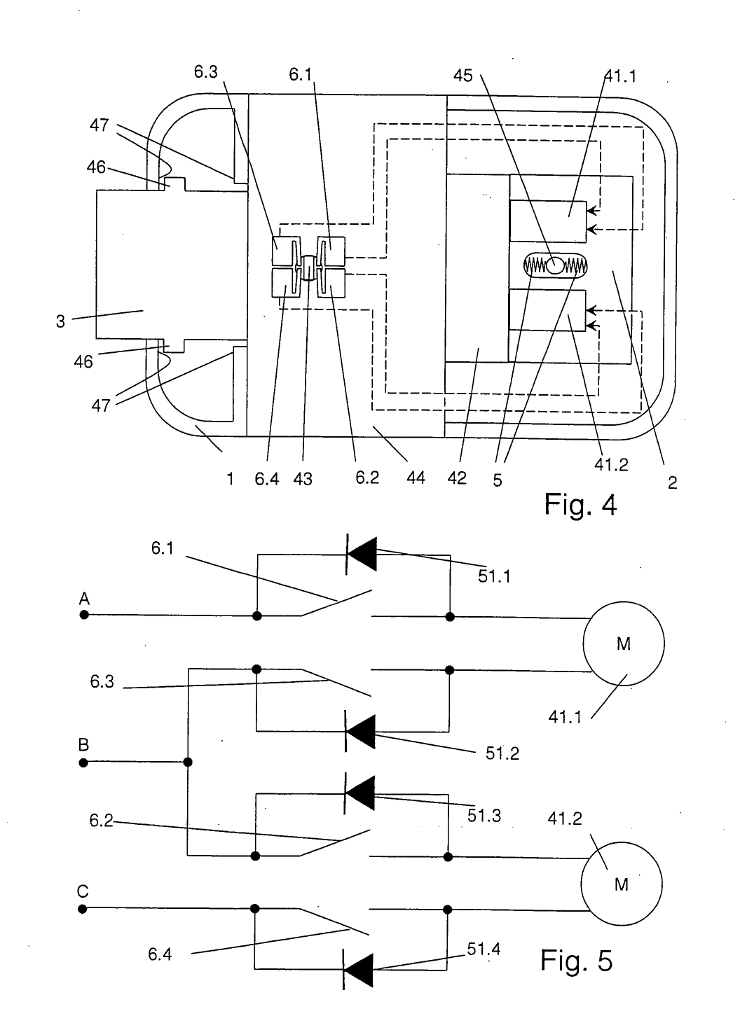

FIG. 4 shows—still schematically—a realisation of the first embodiment of the invention. The base 1 is implemented as a shell for the locking device. The slide 2 comprises two electric motors 41.1, 41.2, which, together with a driving mechanism block 42, form a drive for the bolt 3. The slide further comprises a switching pin 43 for actuating switches 6.1-6.4 when the slide is displaced relative to the base. A switch carrier plate 44 carrying the switches is mounted fixedly to the base. The switch carrier plate may be a printed circuit board also at least partially comprising the wiring between the switches and the electric motors and potentially some further electronics. Two potentially pre-loaded springs 5 arranged between a holding pin 45 of the base and abutment faces (not visible) of the slide keep the slide in an intermediate position as shown in the drawing when no external force acts upon it.

Two of the switches 6.1, 6.3 are operable to stop a forward or a backward actuation, respectively, by the first motor 41.1, whereas the other two switches 6.2, 6.4 may stop forward and backward actuation, respectively, by the second motor 41.2.

In the figure, also schematically, stops are illustrated. The stops are formed by stopping protrusions 46 of the bolt and corresponding stop faces 47 of the base.

A possible, most simple wiring of the motors and the switches is shown in FIG. 5. In this, the motors 41.1, 41.2 are assumed to be battery driven DC motors. For powering the first motor 41.1 either a positive or a negative voltage—the sign depending on the direction of the movement of the bolt—has to be applied between points A and B, whereas for powering the second motor, a voltage is applied between points B and C. If a positive voltage is applied between A and B, the first switch 6.1 may halt the first motor 41.1, whereas the position of the next switch 6.3 is not relevant, due to the second diode 51.2. If a negative voltage is applied, the second switch 6.3 may halt the motor 4.1 whereas it does not matter whether the first switch 6.1 is open or closed, due to the first diode 51.1. Analogous considerations hold for the second motor. This principle assures that the bolt may be retreated from a blocking position, i.e., if its movement in one direction is blocked, it may still be moved in the other direction.

As can be seen from FIG. 5, the device according to the invention does almost not require any circuitry and electronic elements. The entire functionality including the redundancy of two motors may be implemented using merely a power source, four switches, four diodes and some wiring. This is an important advantage, since although sophisticated electronic parts become increasingly easy to obtain and cheap to manufacture, they still constitute an important possible source of failure.

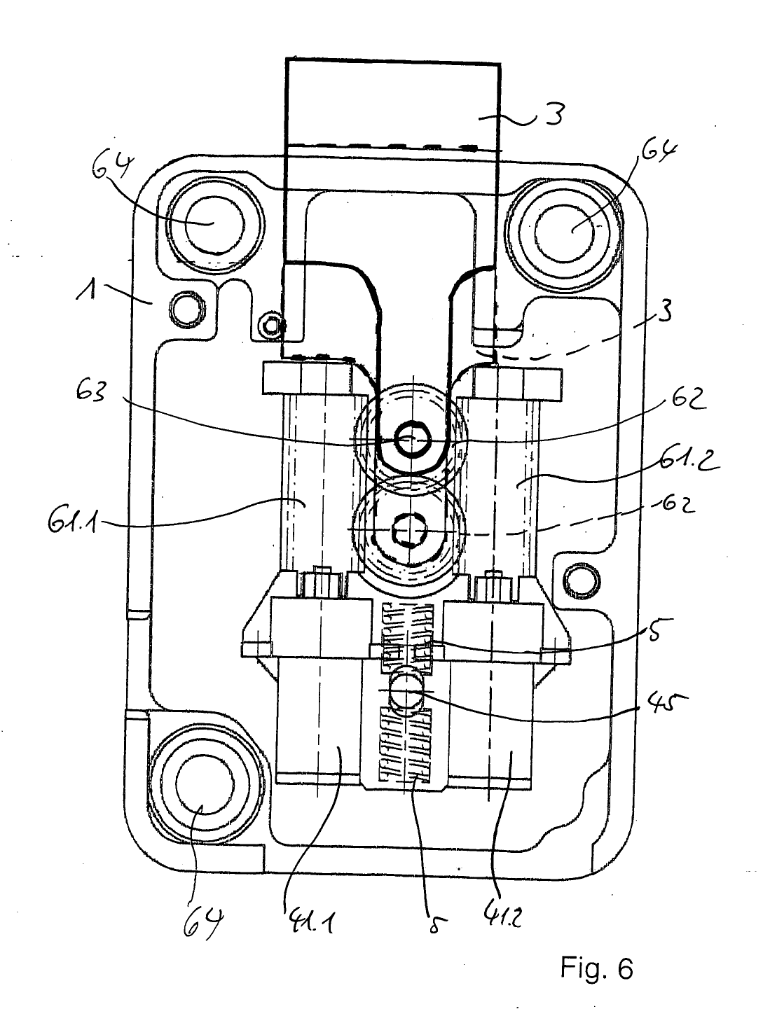

FIG. 6 shows another detail of the realisation of the first embodiment according to FIGS. 4 and 5. From this detail, the functioning of the driving mechanism becomes clear. In the figure, the bolt 3 is shown in two positions. The thick line indicates the position of the bolt close to the locking position, whereas the dashed line shows the bolt in a position close to the release position. Each one of the motors may drive a threaded bar (or spindle) 61.1, 61.2. A toothed wheel 62 (that may, depending on its dimensions, be formed as a helical gear) is located between the two threaded bars. When one of the threaded bars rotates, driven by a motor, the toothed wheel moves back or forth taking along the slidingly mounted bolt to which it is connected by a pin 63. When one of the motors drives its threaded bar, the other motor is not active, and its threaded bar is locked. Usually, no separate locking mechanism is required, due to the self-locking nature of threaded bars co-operating with toothed wheels. As an alternative, the threaded bars—or spindles—may be self-locking only to a certain extent, and the motors or additional means may lock the threaded bars if the motors are not in motion. In the figure, also fastening holes 64 for fastening the base element to a door or frame or the like are shown. Between the motors and the threaded wheels, there may be gear means (not shown) for adapting the rotational speed etc.

Concerning different possibilities to arrange a drive for a bolt in a redundant manner as in FIG. 6 as well as additional means for enhancing the security (such as brake disks for burglary prevention) it is explicitly referred to the document U.S. Pat. No. 5,480,198, especially to the description in col. 4-col. 7, line 21 and the Figures referred to therein. As an example, FIG. 5 of said document and its description show an embodiment where the functions of the wheel (being coupled the motor) and the threaded shaft (serving as propulsion element) are reversed compared to the arrangement shown in FIG. 6.

Instead of the toothed wheel other propulsion elements may be used, especially in realisations of the invention where only one electrical motor is present.

The locking device according to the invention may be arranged to lock a locking member of a safe, a door or the like in the locking position. As an alternative, its locking means may itself serve as a locking bar.

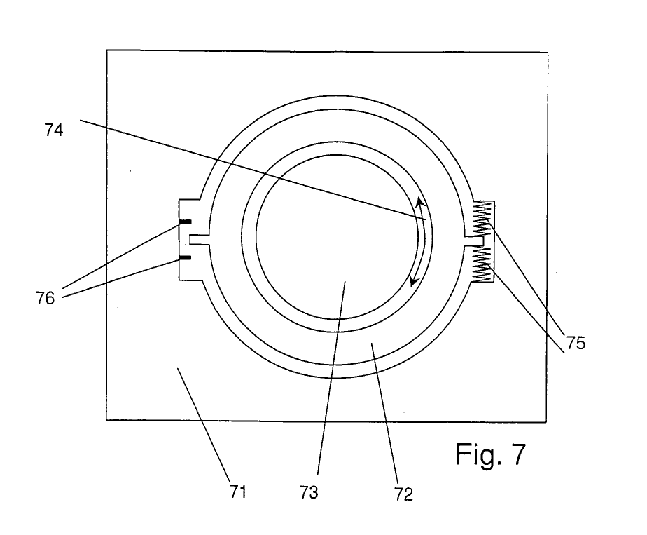

FIG. 7 depicts very schematically a section through a further realisation of the first embodiment of the invention, said realisation being a cylindrical arrangement. The base element 71 is a stator, and the locking means 73 is a rotor. The rotor may serve as a driving element for a bolt (not shown) or be coupled to a driving element. The intermediate element 72 is a hollow shaft arranged between the stator and the driving element. An electrical drive is operable to displace the rotor with respect to the intermediate element 72 by causing a rotary movement as indicated by the arrow 74. As soon as the rotor is blocked since the bolt (or the rotor itself or an other element coupled to the rotor) has reached a stop or because of an event of failure, the intermediate element is caused to rotate against the force of springs 75. By this, one of two switches 76 is actuated, which switch then halts the electrical drive.

The above realisations are merely examples of ways to carry out the invention. They may be altered in many ways.

What is claimed is:

1. Locking device, comprising a base element and a locking means, which is, actuated by an electrical drive, movable relative to the base element between a locking position and a release position, further comprising an intermediate element to which the locking means is movably linked and with respect to which the locking means is movable by the electrical drive, wherein the intermediate element is movably linked to the base element and movable relative to the base element against a resistance of a spring force, the locking device further comprising a sensing means configured to detect a displacement of the intermediate element relative to the base element, wherein the sensing means is configured to stop the electrical drive when a such displacement of the intermediate element has been detected.

2. Locking device according to claim 1, wherein the intermediate element is movable from an equilibrium position against a spring force to two opposite directions into two extreme positions and wherein movement in either direction is detectable by a sensing means.

3. Locking device according to claim 2, comprising two separate sensing means, one detecting a movement in one direction, the other one a movement in the other direction, where the first sensing means is operable to halt the electrical drive when energized so as to displace the locking means towards the locking position but not to halt the electrical drive when energized so as to displace the locking means towards the release position, and wherein the second sensing means is operable to halt the electrical drive when energized so as to displace the locking means towards the release position but not to halt the electrical drive when energized so as to displace the locking means towards the locking position.

4. Locking device according to claim 1 comprising two electrical drives, each drive operable to displace the locking means with respect to the base, and each drive operable to do so also in the event of failure of the other drive.

5. Locking device according to claim 4, wherein the intermediate element is movable from an equilibrium position against a spring force to two opposite directions into two extreme positions, and wherein movement in either direction is detectable.

6. Locking device according to claim 5, comprising four sensing means comprising two separate sensing means, the first and the second sensing means operable to detect a movement in one direction, the third and the fourth sensing means operable to detect a movement in the other direction, wherein the first sensing means is operable to halt the first electrical drive when energized so as to displace the locking means towards the locking position but not to halt the first electrical drive when energized so as to displace the locking means towards the release position, wherein the second sensing means is operable to halt the first electrical drive when energized so as to displace the locking means towards the release position but not to halt the first electrical drive when energized so as to displace the locking means towards the locking position, wherein the third sensing means is operable to halt the second electrical drive when energized so as to displace the locking means towards the locking position but not to halt the second electrical drive when energized so as to displace the locking means towards the release position, and wherein the fourth sensing means is operable to halt the second electrical drive when energized so as to displace the locking means towards the release position but not to halt the second electrical drive when energized so as to displace the locking means towards the locking position.

7. Locking device according to claim 1 wherein the sensing means is operable to distinguish between different levels of displacement.

8. Locking device according to claim 1, wherein the sensing means comprises at least one mechanically actuated switch.

9. Locking device according to claim 3, the two sensing means each comprising a mechanically actuated switch, the first one actuated by a displacement towards the first extreme position, the second one actuated by a displacement towards the second extreme position.

10. Locking device according to claim 6, the first, second, third and fourth sensing means each comprising a mechanically actuated switch.

11. Locking device according to claim 1 comprising at least one limit stop impeding a movement of the locking means relative to the base element beyond at least one of the locking position of the release position, wherein lock does not comprise any separate element halting the electrical drive when the locking position or the release position is reached, so that the sensing means halt the electrical drive when the locking position or the release position is reached.

12. Locking device according to claim 11, wherein an additional sensing means is provided for detecting when the locking means are in the locking position and/or in the release position, so as to be operable to distinguish an incident of failure from a reaching of said position.

13. Locking device according to claim 1 wherein the locking means is a bolt linearly displaceable with respect to the base element, and wherein the intermediate element is a slide on which the bolt is mounted.

14. Locking device according to claim 1 comprising a cylindrical arrangement wherein the locking means is a rotor of the locking device.

15. Locking device according to claim 1 wherein the electrical drive comprises a threaded shaft driven by an electric motor, and a propulsion element linearly displaced by a rotary movement of the threaded shaft, the propulsion element being coupled to the locking means or the intermediate element, respectively.

16. Locking device according to claim 15, wherein the electrical drive comprises two threaded shafts and two electric motors, each electric motor operable to drive one of said two shafts, and wherein the propulsion element is a toothed wheel arranged between the two shafts.

17. Locking device, comprising a base element and a locking means, which is, actuated by an electrical drive, movable relative to the base element between a locking position and a release position, further comprising an intermediate element to which the locking means is movably linked and with respect to which the locking means is movable against a resistance of a spring force, wherein the intermediate element is movably linked to the base element and is movable relative to the base element by the electrical drive, the locking device further comprising a sensing means configured to detect a displacement of the locking means relative to the intermediate element, wherein the sensing means is configured to stop the electrical drive when a such displacement of the locking element has been detected.

18. Locking device according to claim 17, wherein the locking means is movable from an equilibrium position against a spring force to two opposite directions into two extreme positions, and wherein movement in either direction is detectable by a sensing means.

19. Locking device according to claim 18, comprising two separate sensing means, one detecting a movement in one direction, the other one a movement in the other direction, where the first sensing means is operable to halt the electrical drive when energized so as to displace the locking means towards the locking position but not to halt the electrical drive when energized so as to displace the locking means towards the release position, and where the second sensing means is operable to halt the electrical drive when energized so as to displace the locking means towards the release position but not to halt the electrical drive when energized so as to displace the locking means towards the locking position.

20. Locking device according to claim 17, wherein the sensing means comprises at least one mechanically actuated switch.

21. Locking device according to claim 19, the two sensing means each comprising a mechanically actuated switch, the first one actuated by a displacement towards the first extreme position, the second one actuated by a displacement towards the second extreme position.

22. Locking device according to claim 17 comprising at least one limit stop impeding a movement of the locking means relative to the base element beyond at least one of the locking position of the release position, wherein lock does not comprise any separate element halting the electrical drive when the locking position or the release position is reached, so that the sensing means halt the electrical drive when the locking position or the release position is reached.
